(19) United States
(12) Patent Application Publication
(10) Pub. No.: US 2004/0220865 A1
(43) Pub. Date: Nov. 4, 2004

(54) Financial record processing system

(76) Inventors: Stephen Lozowski, West Chester, PA (US); Raymond Owens, King of Prussia, PA (US); Michael Digiacomo, Douglasville, PA (US); Douglas J. Cole, Phoenixville, PA (US); Nicholas Conti, Spring City, PA (US)

Correspondence Address: Alexander J. Burke, Intellectual Property Department, 5th Floor, 170 Wood Avenue South, Iselin, NJ, 08830, US

(21) Appl. No.: 10/789,011

(22) Filed: Feb. 27, 2004

Related U.S. Application Data
(60) Provisional application No. 60/455,233, filed on Mar. 17, 2003.

(51) Int. Cl. G06F 17/60

(52) U.S. Cl. 705/35; 705/3

(57) ABSTRACT

A system for processing a record identifying a liability of a financially responsible party includes an acquisition processor for acquiring a record identifying a portion of a charge related to a service provided to a particular customer by a service provider organization. A data processor identifies a party financially responsible for the charge portion and identifies an account type associated with the charge portion using predetermined rules. The data processor also determines whether an account of the identified type exists for the identified financially responsible party. The data processor also initiates creation of an account of the identified type in response to a determination that an account of that type does not exist. A record processor associates the acquired record with the account of the identified type.

This is a non-provisional application claiming priority from U.S. provisional application serial No. 60/455,233 by S. Lozowski et al. filed Mar. 17, 2003.

### FIELD OF THE INVENTION

This application relates to processing a record identifying a liability of a financially responsible party.

### BACKGROUND OF THE INVENTION

In general, a medical service provider (e.g. an individual doctor, group of doctors, hospital, healthcare organization, and/or the government in the form of government hospitals, etc.) provides a medical service to a patient for a charge (e.g. a dollar amount associated with the provided medical service). Also in general, one or more medical service providers may associate to form a health provider organization which may retain one or more business offices to collect the charges associated with the medical services provided to patients by the providers in the healthcare organization and distribute the collected charges to the appropriate providers.

There are a number of persons or organizations who agree to pay at least a portion of the charge for a medical service provided to a patient by a medical service provider. Many patients have a contract with a payer, for example, an employer, an insurance company or a governmental agency (e.g. state or federal medical insurance plan), in which the payer agrees to pay at least a portion of the charge for medical services provided to that patient. In this situation, one of the business offices associated with the provider sends information describing the medical services provided to the patient and the associated charges to the appropriate payer in a claim. The payer then sends payment to that business office for the claimed services. A payer often does not pay the complete charge for medical services. A patient, therefore, must also have some person or organization which is responsible for paying the portion of the charges not paid by any payer associated with that patient. Such a person or organization is generally referred to as a guarantor. When the payer has paid their share of the charge, the remainder is billed to the guarantor by the business office.

Guarantors may be: the patient himself; a family member, such as a head-of-household for medical services provided to a spouse, a child, and/or another relative; a friend; an employer; a court; a trust; and/or some other organization (such as a school, or prison). For example, in a typical family, one or more of the adult family members may have an insurance contract which will provide at least partial payment for medical services provided to any family member. The adult family member(s), then, acts as a guarantor for all members of that family. In the case of an organization (employer, school, prison), that organization may have many patients for which they act as guarantors.

As described above, charges which are the responsibility of a guarantor are tracked by the business office which dealt with the payer. This may be done through the concept of a guarantor account. The financial concept of an account may be thought of as a way of gathering expense or income items into a group related in some manner, e.g. all expense items related to utilities (electricity, water, etc.) are grouped into a ‘Utilities’ account. The concept of an account has been extended to the concept of a guarantor account. A guarantor account may be thought of as a way of grouping charges for which a particular guarantor is responsible.

Some prior art systems do not include the concepts of guarantor accounts and business offices. Such systems do not reflect the way a typical health provider organization currently bills and collects charges from payers, guarantors and/or other people financially responsible for payment of charges related to the medical services provided to patients.

Some prior art financial record processing systems do not include the concept of a guarantor account but only a patient account (i.e. a way of grouping charges related to providing medical services to a particular patient). In order to manage billing for a guarantor, and particularly a family-type or an organizational guarantor, such systems require a user manually to combine information from one or more patient accounts into a guarantor invoice. Such systems have limitations on reporting information at what would be the guarantor account level or posting payments of the guarantor at such level. For example, a user of such prior art systems would need to manually collect information from various patient accounts to generate a report on a guarantor, would need to combine information from a plurality of patient accounts to generate a bill for a guarantor, and/or would need to manually allocate any resulting payment from the guarantor to the medical providers identified in the plurality of patient accounts.

Some prior art systems include the concept of a guarantor account and provide some means for implementing them manually. However such prior art systems do not automate the creation of such accounts. In such systems, a system user decides whether to create a guarantor account and then decides to which guarantor account to allocate charges. Furthermore, in such prior art systems, use of guarantor accounts is inflexible because only one account per guarantor or one account per guarantor per healthcare provider is supported. Such systems also do not include the concept of business office(s) and do not allow creation of one or more guarantor accounts respectively associated with the different business offices. Consequently, payments received from a guarantor are manually allocated to the business office which originally billed the guarantor. In addition, these prior art systems cannot easily process family-type accounts (described above) and are not designed to handle organizational (e.g. school, prison) guarantor accounts. Such systems either require a user to manually assign charges from one or more associated patient accounts to a guarantor account or assume automatically that a guarantor has just one account. It is evident that manual assignment of charges to a guarantor account is susceptible to user errors which then would require additional manual effort to correct the inaccurate assignment. Further, a single guarantor account does not permit tracking of charges to the guarantor from different business offices.

The prior art systems described above either do not include the concept of a guarantor account, or are limited in that they provide for a single guarantor account, or one guarantor account per healthcare provider.

### BRIEF SUMMARY OF THE INVENTION

The inventors have realized this limitation does not allow for the current practice of one or more business offices performing billing for the health provider organization. This limitation also does not allow for treating different guarantor accounts differently based on user-defined types based on criteria such as the nature of the guarantor and/or that of the charges being collected. More specifically, different guarantor accounts cannot be created based on the nature of the clinical service itself (psychiatric versus normal medical services), on a special or very-important-person (VIP) status of the guarantor and/or any other criterion desired by the health provider organization. These prior art systems cannot vary their actions based on different types of guarantor accounts, and any variation in collection activities has to be manually carried out.

A system is desired which provides for one or more accounts to be associated with a guarantor, which is able to group guarantor portions of charges in different guarantor accounts according to a user-defined criteria, and which includes the concept of a guarantor account associated with a business office is desired. A system according to principles of the present invention addresses these deficiencies and associated problems.

In accordance with principles of the present invention, a system for processing a record identifying a liability of a financially responsible party, includes an acquisition processor for acquiring a record identifying a portion of a charge related to a service provided to a particular customer by a service provider organization. A data processor identifies a party financially responsible for the charge portion and identifies an account type associated with the charge portion using predetermined rules. The data processor also determines whether an account of the identified type exists for the identified financially responsible party. The data processor also initiates creation of an account of the identified type in response to a determination that an account of that type does not exist. A record processor associates the acquired record with the account of the identified type.

### BRIEF DESCRIPTION OF THE DRAWINGS

In the drawing:

FIG. 1 is a conceptual relationship chart showing relationships of a guarantor account with other entities;

FIG. 2 is a block diagram of a system incorporating principles of the present invention;

FIG. 3 is a flow chart showing how a receivable for a guarantor is processed in accordance with the principles of the present invention;

FIG. 4 is a flow chart showing how a deposit from a guarantor is processed using a preferred embodiment of the present invention; and

FIG. 5 is a flow chart showing how a reassignment of a business office is processed.

### DETAILED DESCRIPTION OF THE INVENTION

A glossary is appended to this description describing terms used herein. In the description which follows, a guarantor account conceptually groups charges related to the guarantor and includes a collection of receivables. A receivable conceptually represents the smallest unit of debt for which a provider may expect payment. In the case of a guarantor, a receivable represents the portion of the charge for medical services provided to a patient for which that guarantor, as financially responsible party, is liable. Further, the guarantor may be a person or an organization.

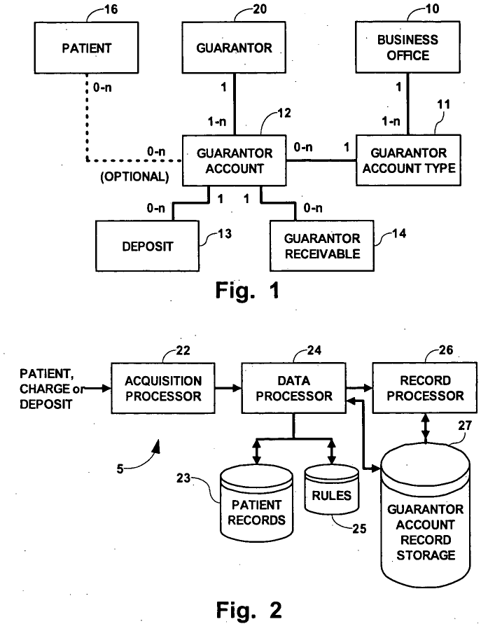

FIG. 1 is a conceptual relationship chart showing the conceptual relationships between a guarantor account and other entities involved in billing medical charges. Rectangles represent different entities of interest in guarantor billing for charges related to medical services provided to patients. Lines between entities represent a relationship between the joined entities. Numbers on the lines near the joined entities represent the number of entities of that type which may be related to the entity at the other end of the line.

As described above, a guarantor account contains information related to the liability that a guarantor, as a financially responsible party, has to a specific business office of a health provider organization. Referring to FIG. 1, a guarantor account 12 is of one guarantor account type 11, though there may be zero, one, or more than one guarantor account 12 of any one guarantor account type 11. A business office 10 may define and specify use of one or more guarantor account types 11 to group guarantor charges as desired by that business office 10, as described in more detail below. Because, for the reasons described above, the collection of a guarantor charge is tracked by a single business office, a guarantor account type 11 specifies the corresponding business office 10 responsible for collecting the guarantor charges in the related guarantor account 12. Consequently, a guarantor account type 11 is related to a single specified business office 10. This ensures that a guarantor account 12 is also related to a single business office 10.

A guarantor account 12 may include zero, one or more guarantor receivables 14, and a guarantor receivable 14 is related to one guarantor account 12. Similarly, a deposit 13 (a payment received in advance for performance of a medical service to a patient), is placed in one guarantor account 12 and the guarantor account 12 may have zero, one or more deposits 13. A guarantor 20 is related to one or more guarantor accounts 12, and a guarantor account 12 is related to one guarantor. It is also possible, though not necessary, for a guarantor account 12 to be related to zero, one or more patients 16 (family-type or organizational guarantors), and a patient may be related to one or more guarantor accounts 12, such as one for psychiatric medical services, and one for regular medical services, and/or one or more guarantors. The optional relationship between a patient 16 and a guarantor account 12 is illustrated in phantom in FIG. 1.

FIG. 2 is a block diagram of a system incorporating principles of the present invention. In FIG. 2, a system 5 is an embodiment implementing the conceptual relationships illustrated in FIG. 1. The embodiment illustrated in FIG. 2 is implemented as a computer system 5. The various entities in FIG. 1 are represented by data. The data is stored in records and those records are arranged into databases, stored in various storage devices attached to the system 5.

In FIG. 2, data representing at least a patient and a charge related to provision of a medical service to that patient is generated by a user of the system 5. An input terminal of an acquisition processor 22 is coupled to receive the patient and charge data from the user. An output terminal of the acquisition processor 22 is coupled to an input terminal of a data processor 24. A first output terminal of the data processor 24 is coupled to an input terminal of a record processor 26. A terminal of the record processor 26 is bidirectionally coupled to a corresponding terminal of a guarantor account record storage device 27. A second terminal of the data processor 24 is bidirectionally coupled to a corresponding terminal of the guarantor account record storage device 27. A patient records storage device 23, containing records of information pertaining to patients, and a rules storage device 25, containing records of information pertaining to rules (described below), are also bidirectionally coupled to the data processor 24.

The operation of the system 5 illustrated in FIG. 2 may be better understood by additional reference to FIG. 1. For a business office (10 of FIG. 1), different guarantor accounts (12) are used to handle guarantor receivables (14) in different billing and collection situations. For example, guarantor receivables (14) for psychiatric services can be placed in different guarantor accounts (12) than guarantor receivables (14) for regular medical services. Guarantor receivables (14) for a special or very-important-person (VIP) can be placed in a separate guarantor account (12) as well. Data stored in the guarantor accounts (12) may be used for further collection actions, including guarantor statement generation and payment posting.

In operation, the acquisition processor 22 interacts with a system user to acquire data representing the identity of a patient (16 of FIG. 1) and at least a portion (e.g. the guarantor portion) of a charge related to a service provided to that patient (16). In the illustrated embodiment, the acquisition processor 22 may include a display device (not shown) such as a CRT or LCD monitor and user input device (also not shown) such as a keyboard and/or a mouse. Programming in the computer system 5 conditions the display device to display an image requesting that the user supply the name of the patient and the guarantor charge portion for the medical service. The system user enters that information using the keyboard and/or mouse, in a known manner.

The acquisition processor 22 may alternatively be a data gathering system, possibly using portable devices, which supplies gathered data to the acquisition processor 22, or may be any other system for gathering at least the required patient and charge data. One skilled in the art will understand that the actual charge amount may be entered by the system user, or may be determined indirectly by entering data describing the medical service which was provided to the patient (16). From that data, the system 5 may automatically calculate the portion of the charge related with that service which is the responsibility of the guarantor. In this configuration, the patient and charge data is placed in a data record and passed to the data processor 24.

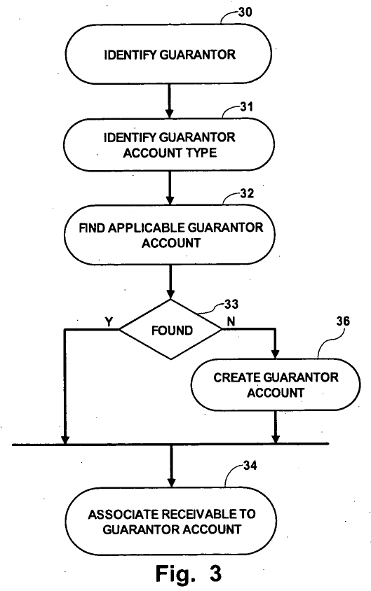

The operation of the data processor 24 may be better understood by reference to FIG. 3. In step 30, the data processor 24 identifies who is the guarantor (20 of FIG. 1) associated with the identified patient (16). This information, among other information related to the identified patient (16), is maintained in a record in the patient records stored in the storage device 23. The data processor 24 accesses the patient record associated with the identified patient from the patient records 23 and extracts data identifying the guarantor (20) associated with the identified patient (16).

In step 31, the data processor 24 then identifies the type (11 of FIG. 1) of guarantor account (12) into which this charge should be placed based on data related to the patient (16), the guarantor (20) and the medical services provided to the patient (16), in a manner to be described in more detail below. More specifically, a set of rules stored in the storage device 25 may be applied to the data related to the patient (16), the guarantor (20) and the medical services, in a manner to be described in more detail below, to determine the type (11) of guarantor account (12) into which data representing this charge is to be placed.

In step 32, the data processor 24 then searches the records representing guarantor accounts (12 of FIG. 1) stored in the guarantor account record storage device 27 to find a record representing a guarantor account (12) of the identified type (11) for the identified guarantor (20). In step 33, if no such record exists, then in step. 36 the data processor 24 creates a guarantor account record of the identified type for the identified guarantor and stores it in the guarantor account record storage device 27. The data processor 24 also creates a record representing a guarantor receivable (14) including at least data representing the patient (16) and the guarantor portion of the charge for the medical service provided to that patient (16). The data processor 24 then forwards the guarantor receivable (14) record to the record processor 26.

As described above, when the data processor 24 completes its operations, a record representing a guarantor account (12 of FIG. 1) of the identified type (11) for the identified guarantor (20) has either been found or created in the guarantor record storage device 27. In step 34, the record processor 26 then updates that guarantor account record (12) by associating data representing the new guarantor receivable record (14) with that guarantor account record (12). In this manner the record processor 26 accumulates guarantor receivable records (14) containing data representing the guarantor charge portions, for one or more patients, in the guarantor account record (12). From the accumulated guarantor receivable records (14) in the guarantor account record (12) the financial liability of the guarantor (20) to the related business office (10) may be determined, a guarantor invoice prepared, and payment tracked.

A new guarantor account may also be created by the data processor 24 upon receipt of a deposit (i.e. pre-payment) (13 of FIG. 1) for a medical service which has not yet been performed. This allows a deposit (13) to be associated with a guarantor account (12) so that the deposit can be properly accounted for and used for calculating the correct payment due when medical services are rendered to a patient related to the guarantor account (12).

The operation of the system 5 for a deposit as described above (FIG. 3) is similar to that for a charge and only the differences will be described in detail below. In this case, the acquisition processor 22 receives data representing a patient and a deposit, instead of receiving data representing a patient and a charge; and a deposit record (13) is ultimately associated with the record representing the appropriate guarantor account (12) instead of a guarantor receivable record (14).

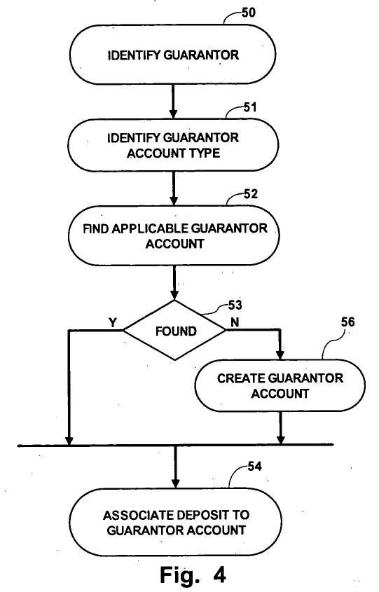

FIG. 4 is a flow chart showing how a deposit from a guarantor is processed. In step 50, the guarantor (20 of FIG. 1) is identified as described above. In step 51, the rules 25 (of FIG. 2) are applied to the acquired data, in a manner to be described in more detail below, to identify the guarantor account type (11). In step 52, the records in the guarantor account record storage device 27 are searched to locate a record representing a guarantor account of the identified type for the identified guarantor. If no such record is located, then in step 56 a guarantor account record of the identified type for the identified guarantor is created. The data processor 24 also creates a record representing a deposit (13) including at least data representing the patient (16) and the deposit amount. In any case, in step 54 the record processor 26 updates the appropriate guarantor account record (12) by associating data representing the new deposit (13) with that guarantor account record (12).

As described above, the system 5 permits a business office (10 of FIG. 1) to define as many guarantor account types (11) as desired. Also as described above, a guarantor account type (11) defined by a business office (10) remains associated with that business office (10). The system 5 also permits a system user to define and maintain rules 25 that enable the system 5 to automatically identify desired guarantor account types (11) according to user-defined criteria. Such criteria may include information concerning e.g. patient, guarantor, medical treatment, and/or any other factor important to the health provider organization. For example, such criteria may be based on a combination of information related to the health provider organization that performed the service (i.e. is the receivable owner). (financial perspective), information related to the medical service provided during the patient's encounter (clinical perspective) and information related to the identification of the guarantor organization, if the guarantor is an organizational guarantor. More specifically, the system 5 may base identification of a guarantor account type (11) on criteria including (a) the health provider organization owed the charge portion, (b) the health provider organization providing the medical service, (c) the type of medical service provided, (d) the primary diagnosis associated with the provided medical service, (e) a special or VIP indicator for the guarantor, (f) the credit rating of the guarantor, (g) the name of the guarantor, and/or (h) the health provider organization identifier. For example, separate guarantor accounts (12) may be created for guarantor receivables (14) related to treatment of medical diseases of a confidential nature, such as AIDS.

Referring again to FIG. 3, in step 31 a guarantor account type (11 of FIG. 1) is identified by invoking a rules processor (not shown, but of known design and operation) in the data processor 24 (of FIG. 2) to apply active guarantor account type identification rules 25 defined by the particular business office (10) to the guarantor receivable (14) and/or deposit (13) data. These rules 25 may be maintained by a system user and contain data representing: basic rule information, matching criteria, and result information as will be explained below.

The basic rule information includes:

(1) The start date of the rule, so that the rules can be made active in the future;

(2) The stop date of the rule so that the rules can be marked inactive as of a certain stop date; and

(3) The sequence number of a rule so that the rules can be evaluated in an order specified by the user.

The matching criteria are defined by a particular business office to identify a guarantor account type. The rules processor in the data processor 24 of system 5 compares data contained in the newly acquired guarantor receivable (14 of FIG. 1) or deposit (13) to the matching criteria in the rules 25 (of FIG. 2) specified by the business office (10) to determine which result information to use. As noted above, the glossary appearing at the end of the application may be referred to for further information concerning the terms used in the following criteria. Any of the specific data listed below may be used within the matching criteria:

(1) Receivable Owner;

(2) Medical Service Provider;

(3) Clinical Service provided to the patient;

(4) Primary Diagnosis for the patient;

(5) VIP Indicator for the Guarantor;

(6) Credit Rating of the Guarantor;

(7) Guarantor Name; and/or

(8) Organizational Identifier, for an organizational guarantor.

Any other such information related to the patient, medical service and/or guarantor which is represented by data values in the acquired guarantor receivable (14) or deposit (13) record, may be evaluated by the rules processor in this manner.

The result information is information that is returned upon a match between data values in the acquired guarantor receivable (14 of FIG. 1) or deposit (13) record and the matching information in a rule. In this case, the result information is data specifying the user-defined guarantor account type which is associated with and unique to one business office. Thus step 31 of FIG. 3, i.e. determining the guarantor account type, is based on the previously set forth rules containing basic information, matching criteria and the result information.

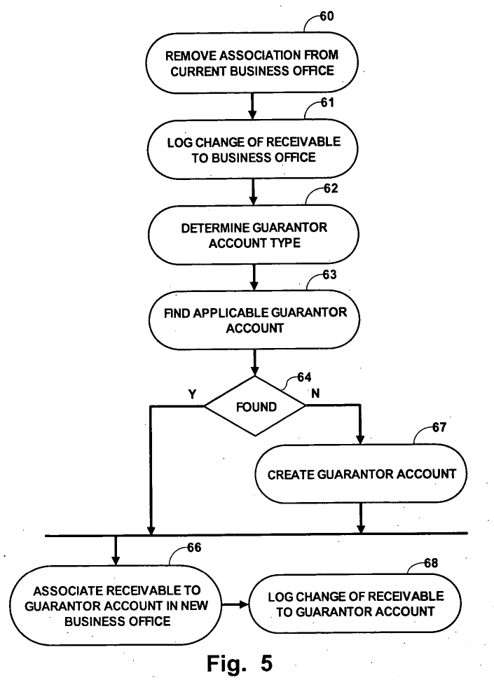

It is sometimes required that a guarantor receivable (14 of FIG. 1) and/or a deposit (13) in a guarantor account (12) to be reassigned from one business office (10) to another. FIG. 5 is a flow chart illustrating how the data processor 24 (of FIG. 2) and the record processor 26 may automatically process such a reassignment.

The first step 60 is to remove the association of the desired guarantor receivable (14 of FIG. 1) or deposit (13) from the current business office (10). The record processor 26 (FIG. 2) searches in the guarantor account record storage device 27 for the guarantor account record (12), with which the desired guarantor receivable record (14) or deposit record (13) is associated. When that guarantor account record (12) is found, the record processor 26 extracts the desired guarantor receivable record (14) or deposit record (13), thus breaking the relationship between that record and the original business office (10). The removal of this guarantor receivable record (14) is noted in a system log for the original business office (10) in step 61. Then the guarantor receivable record (14) or deposit record (13) previously extracted from the original guarantor account record (12) is processed to associate it with an appropriate guarantor account record (12) associated with the new business office (10) as specified by the rules 25 defined by the new business office (10).

The remaining processing illustrated in FIG. 5 is similar to that illustrated in FIG. 3 and FIG. 4. In step 62, the data processor 24 (of FIG. 2) successively applies the rules 25, defined and maintained by the new business office (10 of FIG. 1), to the data contained in the guarantor receivable record (14) or deposit record (13) previously extracted from the old guarantor account (12) to determine the guarantor account type (11) for this guarantor receivable record (14) or deposit record (13) in the new business office (10). In step 63 a search of the guarantor account record storage device 27 is made for a guarantor account record 12 having the identified guarantor account type (11) for the identified guarantor (20). In step 64, if one is not found, then in step 67 a guarantor account record (12) having the identified guarantor account type (11) for the identified guarantor (20) is created and associated with the new business office (10). The data processor 24 then supplies the previously extracted guarantor receivable record (14) or deposit record (13) to the record processor 26. Instep 66, the record processor 26 associates that guarantor account receivable record (14) or deposit record (13) with that guarantor account record (12) in the guarantor account record storage device 27. In step 68 the association of the guarantor account receivable (14) or deposit (13) to the new guarantor account (12) is noted in a system log for the new business office (10).

In FIG. 1 through FIG. 5, and the associated description above, the operation and maintenance of a guarantor account (12 of FIG. 1) by a business office (10) has been described, including the processing of a new guarantor receivable (14), a new deposit (13) and the reassignment of the guarantor receivables (14) and deposits (13) in a guarantor account (12) in one business office (10) to another business office (10). The following is a more detailed example of how the guarantor accounts (12) may be processed. In this example there is one guarantor (20): person A. The person A is financially responsible for himself as well as for one dependant: person B. At this time, neither person A nor person B has been provided any previous service at the particular health provider organization.

The business office (10 of FIG. 1) for a health provider organization has defined guarantor account type identification rules 25 (of FIG. 2) as follows:

| | | Sequence | Criteria | Criteria | Guarantor | Patient Split |
|---|---|---|---|---|---|---|
| Start date | Stop date | Number | type | type | Account Type | Indicator |
| Jan. 01, 2002 | | 1 | Clinical | Psychiatric | “Psych” | N |
| | | | Service | | | |
| Jan. 01, 2002 | | 2 | | | “Standard” | N |

The sequence number is supplied by the system user and is used to specify the sequence of applying rules by the rules processor in the data processor 24 (of FIG. 2). This gives the user the capability to specify: test rule 1 for a match, if no match then test rule 2 for a match, and so forth. The rules 25 set out above result in any guarantor receivable (14 of FIG. 1) or deposit (13) dated after Jan. 1, 2002 and related to a psychiatric encounter being associated with a separate guarantor account (12) of type “Psych” and all other guarantor receivables (14) or deposits (13) dated after Jan. 1, 2002 being associated with a guarantor account (12) of type “Standard”. A reason for doing this may be to segregate guarantor statements for medical services of a more confidential nature, such as psychiatric or AIDS related medical services, from those for medical services of a more mundane nature. This permits access to such statements and records to be restricted to specially authorized personnel both in the business office of the health provider organization and the guarantor organization, if the guarantor is an organization.

Continuing the above example, on date Aug. 1, 2002 person A is admitted to the hospital as a result of an automobile accident. Data representing the patient: person A, and the charge for the medical services provided, is received by the acquisition processor 22 (of FIG. 2), and sent as a data record to the data processor 24. In the data processor 24 the guarantor (20 of FIG. 1): also person A, is determined from an examination of the patient record in storage device 23 for person A. The type of a guarantor account record is determined by applying the guarantor account type identification rules 25 set out above to the acquired patient, guarantor, and medical services data. In this case, the criteria do not match the sequence number 1 rule, but do match the sequence number 2 rule. Consequently, a “Standard” guarantor account type is identified. Because, as stated above, person A has not had any previous contact with this health provider organization or business office, a new guarantor account record, having the identified guarantor account type, “Standard” and identified guarantor, “Person A” is created and stored in the guarantor account record storage device 27. The guarantor receivable (14) record produced by the data processor 24 is forwarded to the records processor 26, which associates that guarantor receivable (14) record with the newly created guarantor account record (12) in the guarantor account record storage device 26.

On Oct. 15, 2002, person A is admitted to the hospital for psychiatric evaluation. The processing is similar to that described above, except when the guarantor account identification rules 25 (of FIG. 2) are processed. In this case, the criteria match on the sequence 1 rule. Because no guarantor account record (12 of FIG. 1) of the “Psych” type for Person A exists, a “Psych” type guarantor account record (12) for Person A is created, and the guarantor receivable (1.4) record for this encounter is associated with that newly created guarantor account record (12).

On Nov. 1, 2002, person B is admitted to the hospital with pneumonia. In this case, the guarantor, Person A, is identified in the data processor 24 (of FIG. 2) by extracting that information from the Person B record in the patient records storage device 23. The guarantor account identification rules 25 match on the sequence 2 rule. Because in this case, a guarantor account record (12 of FIG. 1) of the “Standard” type already exists for Person A, the guarantor receivable (14) record generated for this encounter will be added to that existing “standard” guarantor account record (12) for person A.

A system such as described above provides for one or more guarantor accounts associated with a business office and related to a guarantor. Such a system is able to automatically group guarantor portions of charges, and deposits, in the different guarantor accounts according to user-defined criteria. Generating guarantor bills and processing of guarantor payments is simplified because all guarantor receivable and deposit records are associated with a guarantor account record, and not with patient records. Only the guarantor account record need be processed to generate an accurate bill or receive a payment.

The system described above is applicable to any healthcare field that requires management of guarantor accounts by separate business offices. While the embodiment described above specifically relates to the healthcare enterprise market, such as hospitals and physician organizations, it is extendable to other fields including home health, dental and psychiatry among others. The system is also usable within a patient access and revenue management system managing patient registration.

More broadly, the system is usable in other types of situations where financial responsibility for service performed for a first party can be properly assigned to a second party who has agreed to accept such financial responsibility. Examples of such situations is for automobile repair services. In some cases, an owner's automobile insurance policy may pay for at least a portion of the charges for a repair. Another example is homeowners insurance which, under some circumstances, may pay at least a portion of charges for repair or rebuilding of a house.

While the method and apparatus incorporating the principles of the present invention have been described in specific illustrated examples it is evident that the invention may be practiced as outlined above with modifications within the spirit and scope of the appended claims.

GLOSSARY

| Term | Definition |
|---|---|
| Business | An organization that performs or manages the billing and |
| Office | collection responsibilities of an Health Provider |
| | Organization |
| Charge | A dollar amount associated with a performed service. |
| Clinical | A primary classification of care (e.g. lab, radiology, |
| Service | physical therapy). |
| Clinical | A view based on information related to patient care. |
| Perspective | |
| Deposit | A payment received in advance of the performance of the |
| | service(s). |
| Encounter | A meeting or interaction between a patient and one or |
| | more healthcare providers for the purpose of receiving |
| | one or more health related services. While most |
| | encounters are in person (e.g. hospital admission), |
| | encounters could also occur remotely, as in a telephone |
| | conversation (e.g. phone call to physician) or |
| | an electronic exchange (e.g. email). |
| Financial | A view based on information related to accounting for |
| Perspective | and collecting payment for services rendered to a patient. |
| Guarantor | A person or organization who promises or guarantees to |
| | pay for that portion of the patient's health related services |
| | that are not covered by the patient's insurance plan. |
| | Examples: Patient, Relative, Friend, Employer, Court, |
| | Trust, etc. |
| Guarantor | Contains information related to the financial |
| Account | responsibility that a guarantor has with a specific |
| | business office of a health provider organization. |
| Guarantor | A user-defined categorization of guarantor accounts. |
| Account Type | |
| Guarantor | A receivable that represents the responsibility of the |
| Receivable | guarantor. See Receivable. |
| Guarantor | A “Bill for the Patient”. The statement that contains any |
| Statement | and all amounts due for all the patient charges in a |
| | guarantor account, and is sent to the guarantor. |
| Health | An organization that either directly provides health |
| Provider | services to consumers or the hierarchical parent of an |
| Organization | organization that provides services to consumers. |
| Patient | A person who has received services from a healthcare |
| | provider. A recipient of a healthcare service. |
| Payer | An organization which pays for or underwrites coverage |
| | for healthcare expenses. A payer may be the government |
| | (for example, Medicare), a nonprofit organization (such |
| | as Blue Cross/Blue Shield), a commercial insurance |
| | (such as Cigna), or some other organization. |
| Provider | A hospital or other healthcare institution or health care |
| | professional that provides health care services to patients. |
| | A “provider” may be a single hospital, an individual, a |
| | group, organization, or even the government. |
| Receivable | The smallest unit of debt for which the provider can |
| | expect payment and calculate payment discrepancies. In |
| | most healthcare information systems, this will be a |
| | grouping of multiple charges. For those providers that do |
| | not group charges, this term could refer to an individual |
| | charge. A receivable is collected by one business office |
| | at any point in time. |
| Receivable | Represents the Health Provider Organization to which the |
| Owner | payments are made for healthcare services. |
| VIP Indicator | An indication that a person is considered a special or |
| | very-important-person (VIP) to an organization. |

What is claimed is:

1. A system for processing a record identifying a liability of a financially responsible party, comprising:
an acquisition processor for acquiring a record identifying a portion of a charge related to a service provided to a particular patient by a health provider organization;
a data processor for:
identifying a party financially responsible for said charge portion and for identifying an account type associated with said charge portion, using predetermined rules;
determining whether an account of said type exists for said identified financially responsible party; and
initiating creation of an account of said type in response to a determination an account of said type does not exist; and
a record processor for associating said acquired record with said account of said type.

2. A system according to claim 1, wherein:
said account of said type is associated with a business office of said health provider organization and
said financially responsible party is a guarantor undertaking to pay said charge portion.

3. A system according to claim 2, wherein said charge portion comprises a portion of said charge related to said service provided to said particular patient by said health provider organization and said charge portion is un-reimbursable under medical insurance of said particular patient.

4. A system according to claim 2, wherein said record processor accumulates records of charge portions related to services provided to said particular patient in a record representing said account of said type to determine financial liability of said guarantor payable to said business office.

5. A system according to claim 4, wherein said record processor accumulates records of charge portions related to services provided to a plurality of patients in a record representing said account of said type to determine financial liability of said guarantor payable to said business office.

6. A system according to claim 1, wherein:
said acquisition processor acquires a second record identifying a financial sum received in payment of at least a partial amount of said charge portion, and
said record processor associates said acquired second record with said account of said type.

7. A system according to claim 1, wherein said data processor identifies said account type by matching characteristics of said acquired record with characteristics identifying a predetermined account type, said characteristics including at least one of, (a) a health provider organization owed said charge portion, (b) a health provider organization providing said service, (c) a service identifier identifying said provided service type, (d) a primary diagnosis identifier associated with said provided service, (e) a special or very important-person (VIP) indicator, (f) a credit rating from said financially responsible party, (g) a name of said financially responsible party and (h) a health provider organization identifier.

8. A system according to claim 1, wherein said data processor identifies said account type using said predetermined rules and said predetermined rules are applied in response to characteristics including at least one of, (a) a rule-start date, (b) a rule termination date and (c) a sequence number used by the system to determine a sequence of applying rules.

9. A system according to claim 1, wherein said charge portion comprises a part or an entirety of said charge.

10. A system according to claim 1, wherein said data processor determines whether said account of said type exists for said identified financially responsible party by matching account type and financially responsible party identification information with stored account type and financially responsible party data.

11. A system for processing a record identifying a liability of a guarantor undertaking to pay at least a portion of a charge for a service, comprising:
an acquisition processor for acquiring a record identifying a portion of a charge related to a service provided to a particular customer by a service provider organization;
a data processor for:
identifying a guarantor for said charge portion and for identifying an account type associated with said charge portion, using predetermined rules;
determining whether an account of said type exists for said identified guarantor; and
initiating creation of an account of said type in response to a determination an account of said type does not exist; and
a record processor for associating said acquired record with said account of said type.

12. A system according to claim 11, wherein:
said data processor associates said account of said type with a business office in response to command; and
said record processor associates said acquired record with said account of said type and said business office.

13. A system according to claim 12, wherein said data processor removes an association of said account of said type with a previous business office in response to command.

14. A method for processing a record identifying a liability of a financially responsible party, comprising the activities of:
acquiring a record identifying a portion of a charge related to a service provided to a particular customer by a provider organization;
identifying a party financially responsible for said charge portion and for identifying an account type associated with said charge portion, using predetermined rules;
determining whether an account of said type exists for said identified financially responsible party;
initiating creation of an account of said type in response to a determination that an account of said type does not exist; and
associating said acquired record with said account of said type.

15. A method for processing a record identifying a liability of a guarantor undertaking to pay at least a portion of a charge for a service, comprising the steps of:
acquiring a record identifying a portion of a charge related to a service provided to a particular patient by a health provider organization;
identifying a guarantor for said charge portion and identifying an account type associated with said charge portion, using predetermined rules;
determining whether an account of said type exists for said identified guarantor;
initiating creation of an account of said type in response to a determination that an account of said type does not exist; and
associating said acquired record with said account of said type.
